(19) United States
(12) Patent Application Publication
(10) Pub. No.: US 2019/0209932 A1
(43) Pub. Date: Jul. 11, 2019

(54) User Interface for an Animatronic Toy

(71) Applicant: American Family Life Assurance Company of Columbus, Columbus, GA (US)

(72) Inventors: Joel B Schwartz, Los Angeles, CA (US); Aaron J. Horowitz, Providence, RI (US); Hannah Chung, Providence, RI (US); Brian Oley, Jamaica Plain, MA (US); Joshua William Garrett, San Francisco, CA (US); Oliver Raleigh Mains, Oakland, CA (US); Audrey Nieh, San Francisco, CA (US)

(73) Assignee: American Family Life Assurance Company of Columbus, Columbus, GA (US)

(21) Appl. No.: 15/863,844

(22) Filed: Jan. 5, 2018

(51) Int. Cl. A63H 3/00; G06F 3/16; H04R 1/02; A63H 3/28; A63H 3/02; A63H 30/04

(52) U.S. Cl. CPC A63H 3/003; G06F 3/165; H04R 1/028; A63H 3/28; H04W 4/80; A63H 3/02; A63H 30/04; H04R 2400/03; A63H 3/001

(57) ABSTRACT

An animatronic doll is disclosed. The doll, includes multiple sensors, one or more of which receives input which causes the doll to perform various functions such as moving, vibrating, playing music, eating, interacting with a mobile app or interacting with another doll. The doll also includes various modes which may be effected or selected based on input from one or more sensors. One of the sensors may include an rfid reader which reads cards that instruct the doll to emulate a particula emotion.

### FIELD OF THE TECHNOLOGY

The technology of this application relates generally to a child's toy and more specifically but not exclusively to one or more user interfaces for an animatronic duck shaped toy.

### BACKGROUND OF THE TECHNOLOGY

An animatronic toy is typically a plastic figure in the shape of an animal, person or fictional character, which has internal gears and controllers that move parts of the toy to mimic organic movements. Animatronic toys have existed since at least the mid-1980s with the introduction of toys such as Teddy Ruxpin™, a bear whose mouth and eyes moved while he read stories that were played from an audio tape cassette deck built into its back, and others.

Animatronic toys have a potential use not only for play, but also in a healthcare setting. It is well known that pet therapy can provide comfort and emotional support to people of all ages. The movement and interaction of an animatronic toy simulating an animal, can provide a similar form of therapy to those who do not otherwise have access to pet therapy.

Animatronic toys can further assist in a healthcare setting with both children and adults who are receiving treatment for illness by providing a method to communicate emotions. Communicating emotions can be very difficult for young patient receiving medical care, particularly those affected by cancer and autism. [0005] Conventional toys of this nature have limited interactive capabilities.

It may be advantageous to create an animatronic toy with a robust user interface.

### BRIEF SUMMARY OF THE TECHNOLOGY

Many advantages will be determined and are attained by one or more embodiments of the technology, which in a broad sense provides an animatronic toy. The toy may leverage the use of interactive play to help patients communicate their emotions with other family members and caregivers. The toy may be employed to provide comfort, emotional support, and joy to people undergoing medical treatments—particularly children undergoing chemotherapy. The toy may be an animatronic representation of duck. Various movements of the duck may mimic lifelike movements of a duck. For example, the duck may tilt its head forward and open its mouth, or the duck may tilt its head left or right or the duck may turn its head right or left while leaning its body in the opposite direction. Additionally, the duck may respond to environmental stimuli such as light, dark, sound, movement, or emotion cards/disks and/or it may interact with a software application on a computer or smart device.

In one or more embodiments an interactive doll that performs automated movements is provided. The doll includes an outer shell that forms a shape of the doll. The doll may also include various movable body parts within the outer shell. The body parts may be moved through motors disposed within the outer shell. Multiple sensors may be disposed on the outer shell and at least one processor may be in electrical communication with the sensors. At least one identification card readable by at least one of the sensors may be included. The identification card identifies a mode for the doll. The processor may place the doll into a mode identified by the identification card.

In one or more embodiments a method of interacting with a doll that performs automated movements is provided. The method includes a light sensor in the doll detecting a light environment around the doll. It also includes a processor receiving the light indication from the light sensor and placing the doll into a mode that includes the doll emulating hunger.

The technology will next be described in connection with certain illustrated embodiments and practices. However, it will be clear to those skilled in the art that various modifications, additions and subtractions can be made without departing from the spirit or scope of the claims.

### BRIEF DESCRIPTION OF THE DRAWINGS

For a better understanding of the technology, reference is made to the following description, taken in conjunction with any accompanying drawings in which:

FIG. 1 illustrates a front view of an exemplary animatronic doll including one or more sensors and cards in accordance with one or more embodiments of the disclosed technology;

FIG. 2 illustrates a perspective view of the doll of FIG. 1 without the outer skin, showing various sensors in accordance with one or more embodiments of the disclosed technology;

FIG. 3 illustrates a side view of the doll of FIG. 1 without the outer skin, showing various sensors in accordance with one or more embodiments of the disclosed technology;

FIG. 4 illustrates a rear view of the doll of FIG. 1 without the outer skin, showing various sensors in accordance with one or more embodiments of the disclosed technology;

FIG. 5 illustrates a mobile device running an app connected to the doll of FIG. 1 and the doll of FIG. 1 communicating with other dolls in accordance with one or more embodiments of the disclosed technology;

FIG. 6 illustrates a flow chart of a main mode of the doll of FIG. 1 in accordance with one or more embodiments of the disclosed technology;

FIG. 7 illustrates a flow chart of a card interaction mode of the doll of figure lin accordance with one or more embodiments of the disclosed technology;

FIG. 8 illustrates a flow chart of a medical card interaction mode of the doll of FIG. 1 in accordance with one or more embodiments of the disclosed technology; and

FIG. 9 illustrates a flow chart of a light environment mode of the doll of FIG. 1 in accordance with one or more embodiments of the disclosed technology;

FIG. 10 illustrates a flow chart of a dark environment mode of the doll of FIG. 1 in accordance with one or more embodiments of the disclosed technology;

FIG. 11 illustrates a flow chart of the doll of FIG. 1 interacting with another doll in accordance with one or more embodiments of the disclosed technology; and

FIG. 12 illustrates a flow chart of the doll of FIG. 1 interacting with a mobile software application accordance with one or more embodiments of the disclosed technology.

The technology will next be described in connection with certain illustrated embodiments and practices. However, it will be clear to those skilled in the art that various modifications, additions, and subtractions can be made without departing from the spirit or scope of the claims.

### DETAILED DESCRIPTION OF THE TECHNOLOGY

One or more embodiments of the technology provides, in a broad sense, a user interface for an animatronic doll. A doll such as an animatronic duck is provided which may include, among other things, a speaker, various input devices/sensors, a movable beak, a tongue within the moveable beak, wings and feet. The duck may perform various conjoined or individual movements such as a tilting of the head forward while opening the beak, turning the head to the right or left while the body tilts in the opposite direction, or tilting the head right or left. The duck may also provide sounds in conjunction with the movements or separate from the movements. The duck may slow down when it is dark, may dance when it senses music, and may display emotions based on interaction with emotion cards/disks or software applications.

Discussion of an embodiment, one or more embodiments, an aspect, one or more aspects, a feature, one or more features, a configuration or one or more configurations, an instance or one or more instances is intended be inclusive of both the singular and the plural depending upon which provides the broadest scope without running afoul of the existing art and any such statement is in no way intended to be limiting in nature. Technology described in relation to one or more of these terms is not necessarily limited only to use in that embodiment, aspect, feature, configuration or instance and may be employed with other embodiments, aspects, features, configurations and/or instances where appropriate.

For purposes of this disclosure “doll” means an animatronic scaled figure which has the shape of a person, animal or creature. The doll may be completely animatronic, or a combination of animatronic and manually movable parts. While the disclosure may refer to a duck shaped doll or simply a duck, the technology is not so limited. This reference is made for ease of explanation only and is not intended to be limiting as far as the shape or size of the doll. Disclosure related to the duck may be applied or related equally to other dolls that have a similar shape.

For purposes of this disclosure “sensor” means one or more photodetectors, capacitive sensors, radio frequency (rf) sensors, cameras, microphones, Bluetooth Low Energy (BLE) detectors, WiFi detectors, ProSe detectors, LTE-D detectors accelerometers, code readers, buttons or switches.

For purposes of this disclosure “card” or “disk” means an object that includes some form of identification that can be read and identified by a sensor.

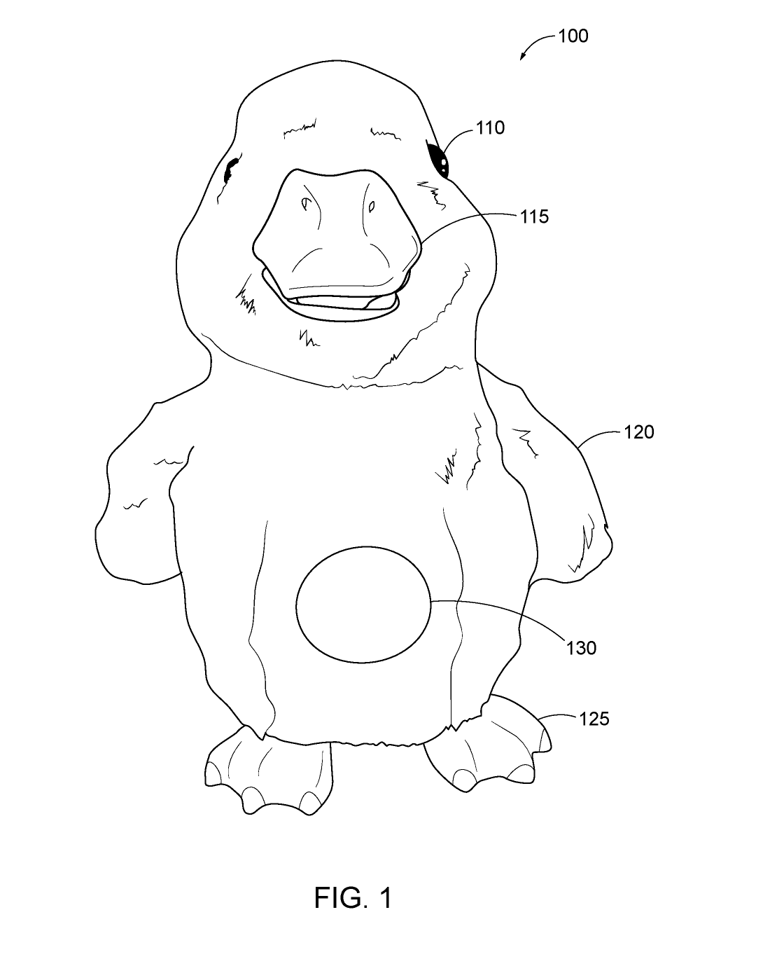

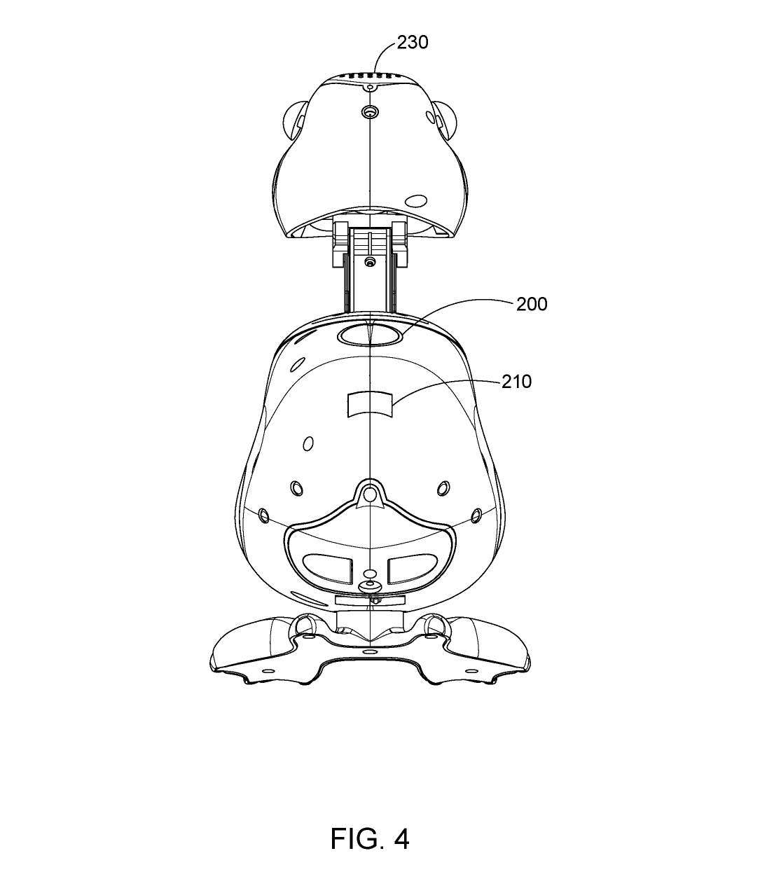

FIGS. 1-4 illustrate various aspects of an animatronic duck 100. FIG. 1 illustrates duck 100 fully assembled with a plush outer skin that simulates an actual duck. As illustrated, duck 100 may include two eyes 110, a beak 115, wings 120 and feet 125. Duck 100 may also include one or more sensors 130. One or more sensors may be employed to activate various movements and/or sounds. In addition, the duck 100 may include various direct current (DC) motors, shafts, gears, cams and cam followers which combine in various combinations to enact various movements of duck 100. The movement of the duck is described more fully in the U.S. patent application entitled Animatronic Toy, which is being filed concurrently herewith, which has at least one common inventor, and which is incorporated herein as if fully set forth.

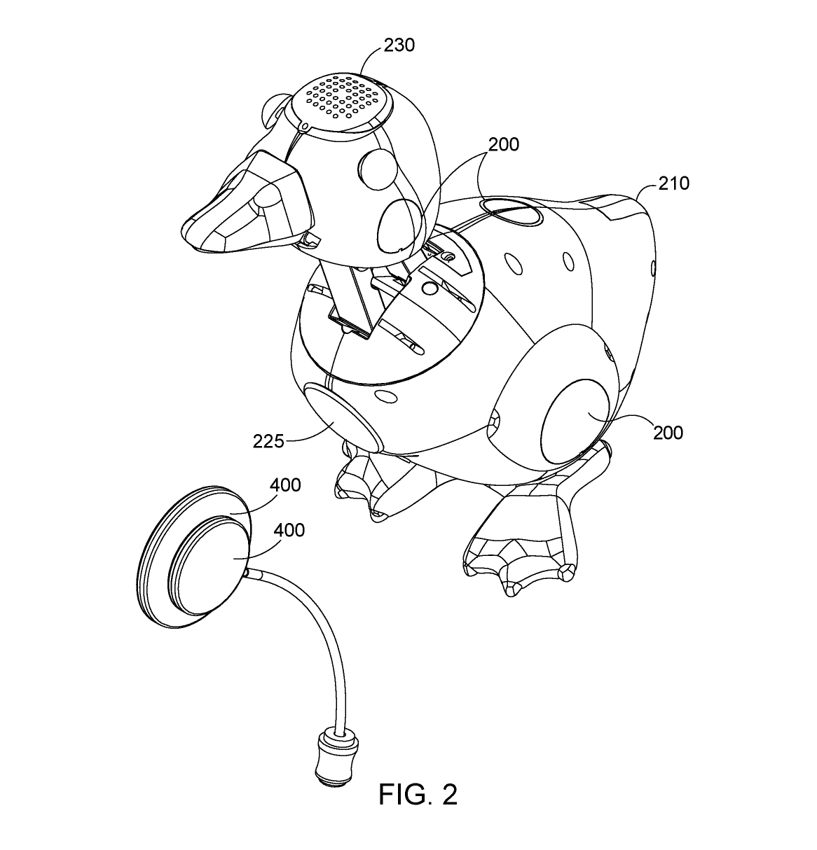

FIGS. 2-4 illustrate an embodiment of the doll 100 with the skin removed. FIG. 2 illustrates that the duck may include sensors 130 in various locations on the doll 100. Different locations may cause different reactions from the duck 10 and/or they may cause the same reaction(s). Sensors 130 in different locations may be the same type of sensor 130, different types of sensors 130 or there may be multiple different types of sensors 130 in a particular location on the doll 100. The embodiment illustrated includes 5 capacitive sensors 200, 2 button sensors 210, an accelerometer, switches, a radio frequency identification (“rfid”) reader, a microphone, a photocell light detector, a BLE detector, and a slider switch, although the technology is not limited to this embodiment.

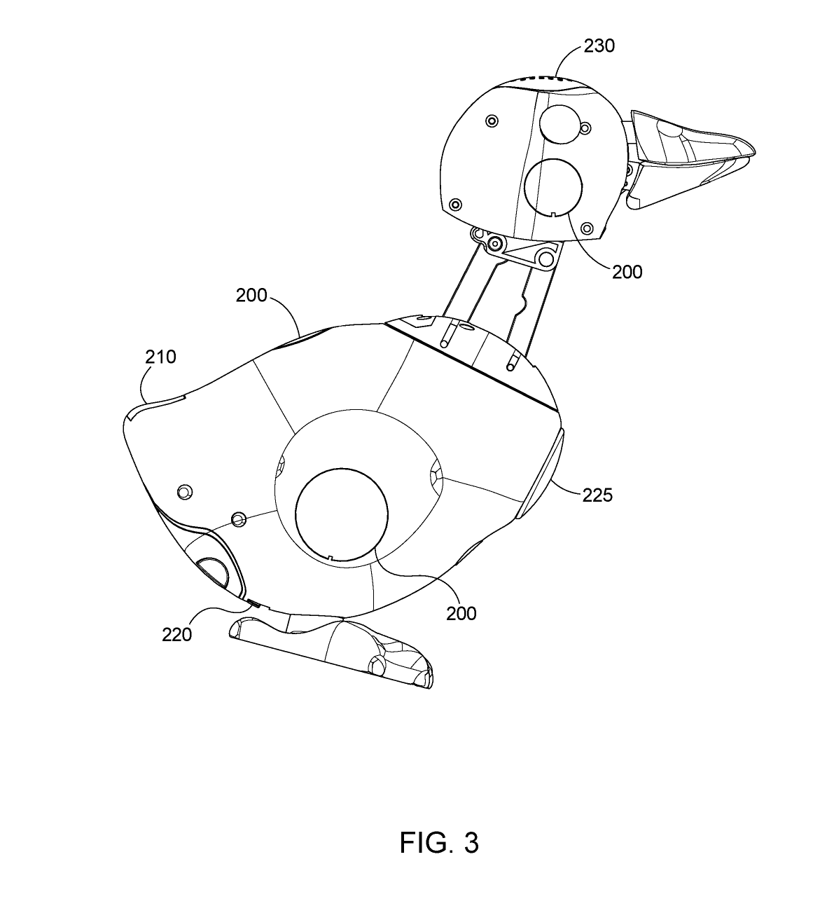

FIGS. 2 and 3 illustrate that the capacitive sensors 200 may be located on each wing, one each side of the head and on the back. When activated, the capacitive sensors 200 may cause the duck to vibrate and make a nuzzling noise to emulate being pet. The vibration may be caused by a vibrational speaker 230 located at the top of the head. Vibrational speaker may be utilized to emulate breathing and/or a heartbeat. Alternatively, or additionally, one or more vibrational motors may be located within the duck to cause the duck to vibrate. Buttons 210 may be located in the beak (not illustrated) and on the back. The button in the beak 115 (which may be located on a tongue) may cause the duck 100 to make eating sounds and may be utilized in one or more routines for emulating feeding duck 100. The button 210 on the back may have multiple uses such as to wake the duck from a sleep mode and to trigger a Bluetooth broadcast and/or detection for interaction with another doll 100 and/or for interaction with a software application (“app”). Accelerometer, which may be located inside the frame of the duck 100 may be employed to detect shaking or tilting of the duck which may be employed to place the duck in an agitated state or to make the duck produce a specified sound. One or more microphones may be employed to detect music or other sounds/commands which, in the case of music, may cause the duck to simulate dancing. The microphone may be collocated with the speaker 230 or it may be located elsewhere in the duck. Photocell light sensor, not illustrated, may be utilized to detect dark and light environments. Depending on which environment is detected, the duck 100 may be placed into a defined routine or state. A BLE detector/transmitter may be located within duck 100 (not illustrated). BLE detector/transmitter may be utilized to connect to mobile devices and/or other dolls 100. A slider switch 220 may be located on the bottom of the duck 100 and may be employed to turn duck 100 on and off or to mute duck 100. FIGS. 2-4 also illustrate an rfid reader 225 located on the chest of duck 100.

Rfid reader 225 may be employed to detect and/or connect with emotion cards 400 such as happy, sad, anxious, angry, sick scared, calm, sad and silly. Additional, different and/or fewer emotion cards 400 may be employed. An emotion card 400 may be a circular plastic disk which includes a radio frequency id tag. The disk may include a printed pictographic image and/or it may include an embossed or molded image of a facial expression to express the associated emotion. The image may be accompanied by one or more printed or embossed words. An emotion card need not be circular nor does it have to be made of plastic. Additionally, different emotion cards may be different shapes and/or materials. Emotion cards 400 may provide different or additional functionality other than emotions. For example, one or more cards 400 may provide a soundscape such as ocean waves, or birds chirping. The only requirement for this embodiment is that the emotion card 400 can be read by rfid reader 225. Duck 100 may be configured to read only 1 emotion card at a time or it may be configured to interact with multiple emotion cards 400 at the same time.

When an emotion card 400 is touched to rfid reader 225 a related program may be triggered. For example, if a silly card 400 is detected duck 100 may giggle, or if the sad card is detected the duck may make a crying sound. In addition to producing a sound, duck 100 may perform one or more movements in response to detection of an emotion card 400. While rfid reader 225 and rfid cards 400 have been disclosed, the technology is not so limited. The emotion detection may be accomplished by near field communication technology, infrared (“ir”) cameras and it markers, or a camera with object recognition technology. Additionally, it may be required or optional to attach emotion card 400 to rfid reader 225.

One type of emotion card 400 provide a medical port simulation. This allows the duck to empathize with a child who is receiving medical treatments such as Chemotherapy. When this card 400 is employed, duck 100 may act as if it is receiving the medical treatments. For example, the first time the duck 100 may be apprehensive with jerky movements and as it receives additional treatments the movements may become more relaxed and smooth.

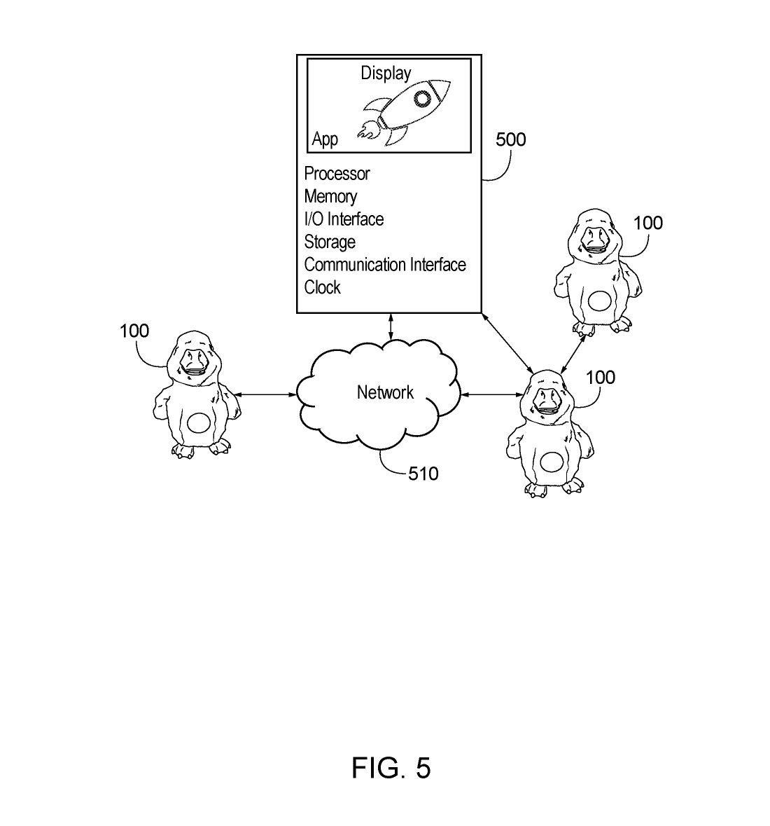

FIG. 5 illustrates that duck 100 may operate with a mobile device 500 such as a smart phone that runs one or more apps that interact with duck 100. Mobile device 500 may connect to duck 100 via a network such as WiFi or it may connect via Bluetooth or some other wireless connection. As with most apps, the user may sign up for the app by entering name, password and any other conventional information that is usually entered for signing up for an app. Those skilled in the art will recognize that the information collected is a design choice. Once the user signs up for the app, the user may be presented with a login screen. The information collected for this purpose is also a design choice as is the decision whether to require a login. The duck may need to be paired with a mobile device 500. This may be accomplished by pressing the button 210 and selecting the broadcast signal from the mobile device. In one or more embodiments, pairing may require holding down button 210 for at least a certain amount of time, or it may require multiple presses to indicate that the desired task is pairing. The app may provide the user with the ability to utilize the duck as a soundscape (e.g. waves on a beach, rain, birds, etc.) and it may provide the ability to modify various functionality on duck 100. For example, the app may provide the ability to raise or lower the volume of speaker 200, it may provide the ability to update software on duck 100, it may provide the ability to perform a function typical initiated by a sensor. It may provide the ability to run a movement routine such as turning the head and tilting the body and/or it may provide the ability to turn duck 100 on or off. It may also provide the ability to create a customized soundscape (e.g. a collection of background sounds that simulates a physical location or environment for the listener such as crickets, chirping birds, a babbling brook, and light wind combined to sound like a forest, or some other collection of sounds). Soundscapes may be triggered to help comfort a patient during a stressful time (e.g. during a healthcare situation).

Duck 100 may also be provided with various outputs that work in conjunction with the inputs. As discussed above, speaker 200 may broadcast sounds from duck 100 and/or cause duck 100 to vibrate. In addition, duck 100 may be provided with one or more light emitting diodes (“LEDs”)(not illustrated). The LEDs may be employed to indicate a need for a particular interaction and/or to indicate a particular response, routine or status.

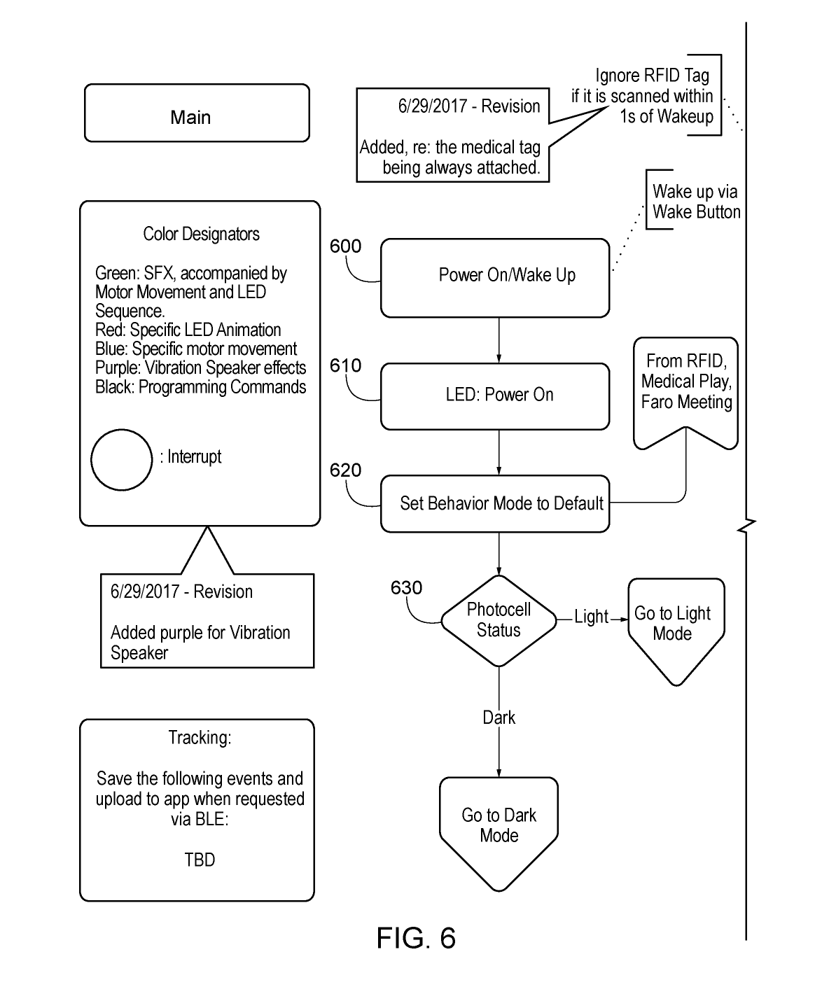

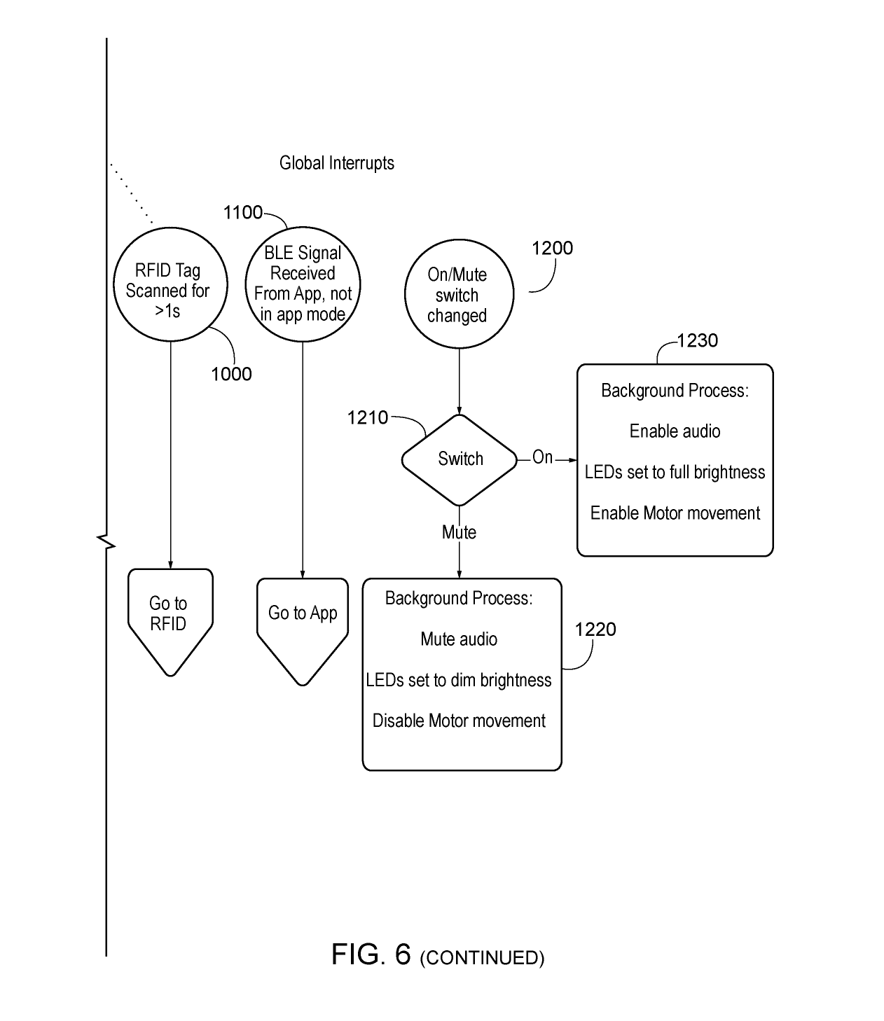

FIG. 6 provides a possible operational flow chart for duck 100 at initial power on or wake from sleep mode 600. Initially, LEDs light up. They may light up in a pattern and then light at their initial default setting or they may light directly into their default setting. At step 620 the behavior of duck 100 is set to a default mode. The actual default mode is a design choice and may be hungry, content, silly, etc. The default setting may be a customizable feature through the app. Once in default mode, the light sensor may determine 630 if it is light 635 or dark 640 in the surrounding area. Depending on which environment is detected may determine the next action. If at any time, an rfid tag card 400 is detected/read 1000, a Bluetooth signal is received from an unpaired app 1100 or the mute/on/off switch changes position 1200, the current action may be interrupted and/or deprioritized and the required action taken to accommodate the interrupting action.

If the mute/on/off switch changes position 1200, depending on which position is selected 1210 depends on the next action. If switch 220 is moved to the mute position 1220, the audio may be muted, the LEDs may be dimmed and/or one or more movement capabilities of the duck may be limited or disabled. If switch is moved to the on position 1230 then the audio may be enabled, the LEDs may be set to full brightness (or whichever brightness level is set as default), and one movement capabilities may be enabled.

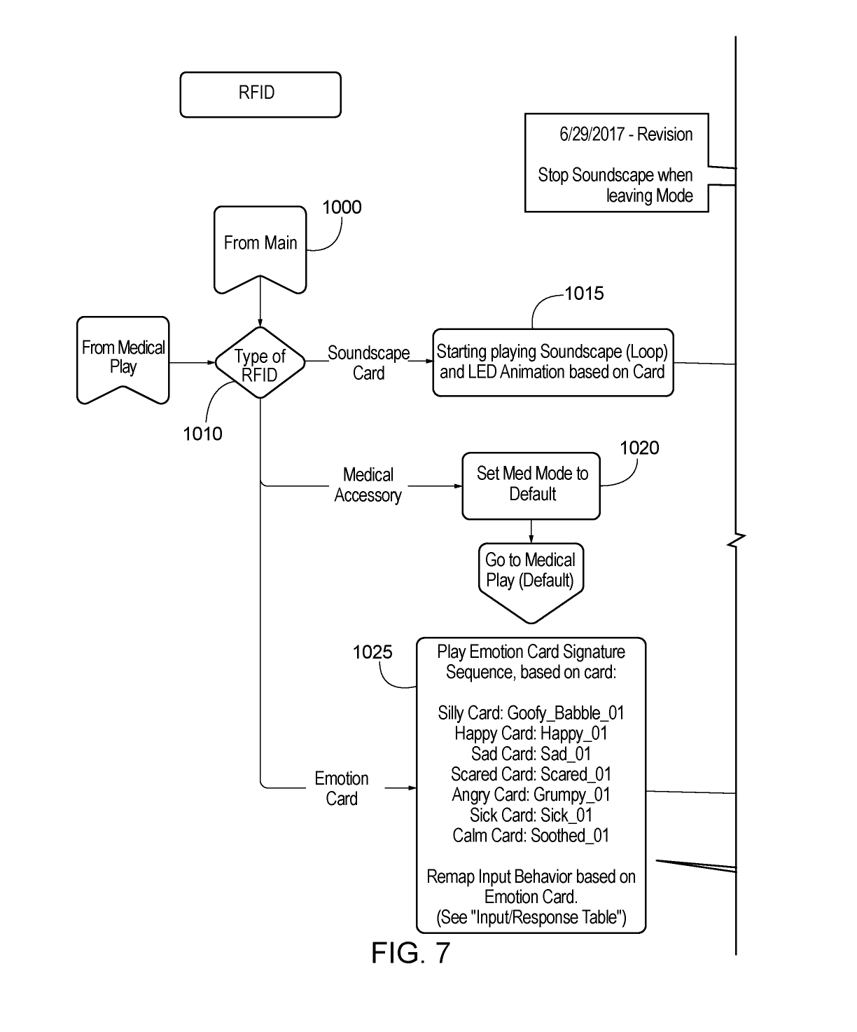

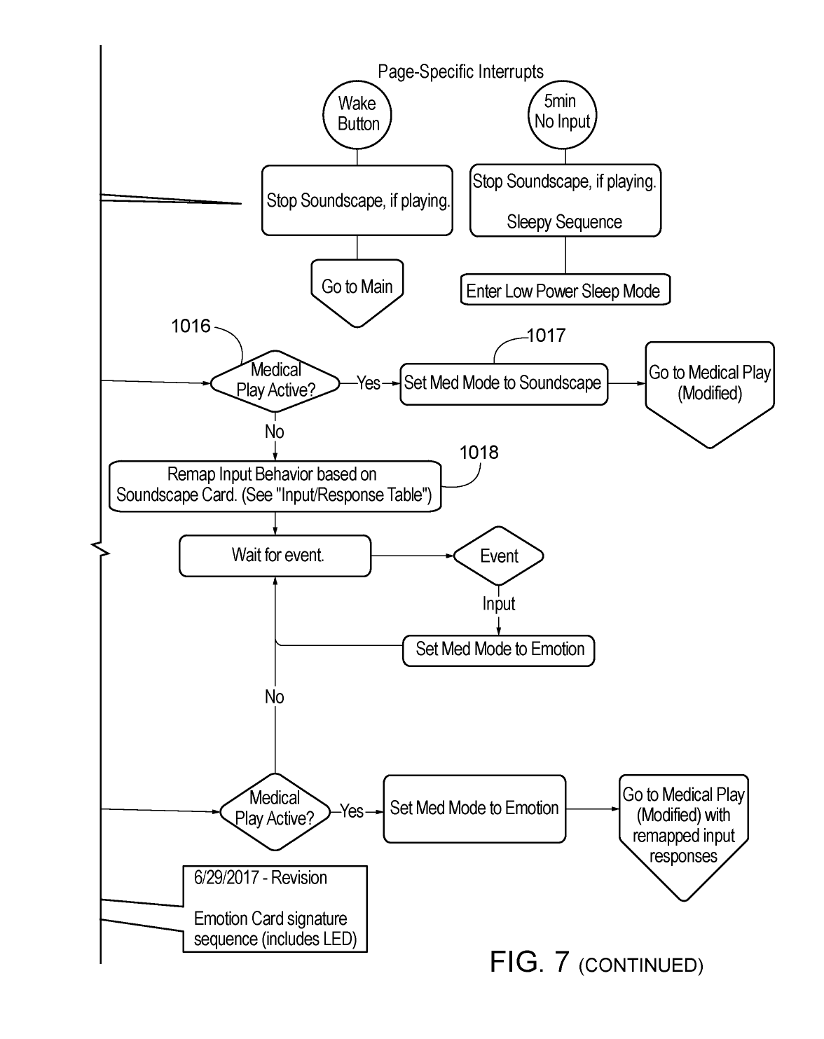

FIG. 7 illustrates scanning of an emotion card 400. Once the card 400 is scanned 1000, the card is identified 1010. If it is determined that the card 400 is a soundscape card, the duck will begin to broadcast the soundscape 1015 from speaker 230. It is then determined if duck 100 is in medical status mode 1016. If duck 100 is in medical status then medical mode may be set to soundscape 1017. If duck 100 is not in medical status mode then an input behavior of duck 100 may be modified based on information on the soundscape card 400. If it is determined that the card 400 is an emotion card 400 then duck 100 performs the functions associated with the emotion (e.g. silly the duck may babble, sad the duck may cry, etc.) and an input behavior of duck 100 may be modified based on information on the emotion card 400.

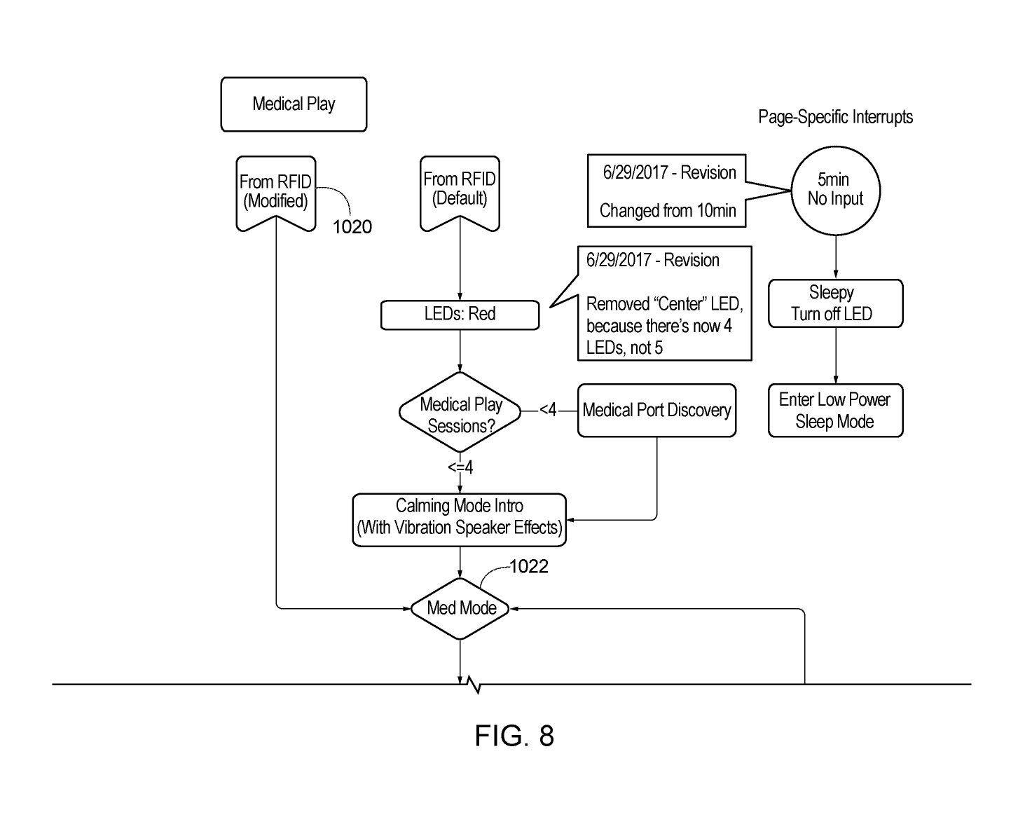

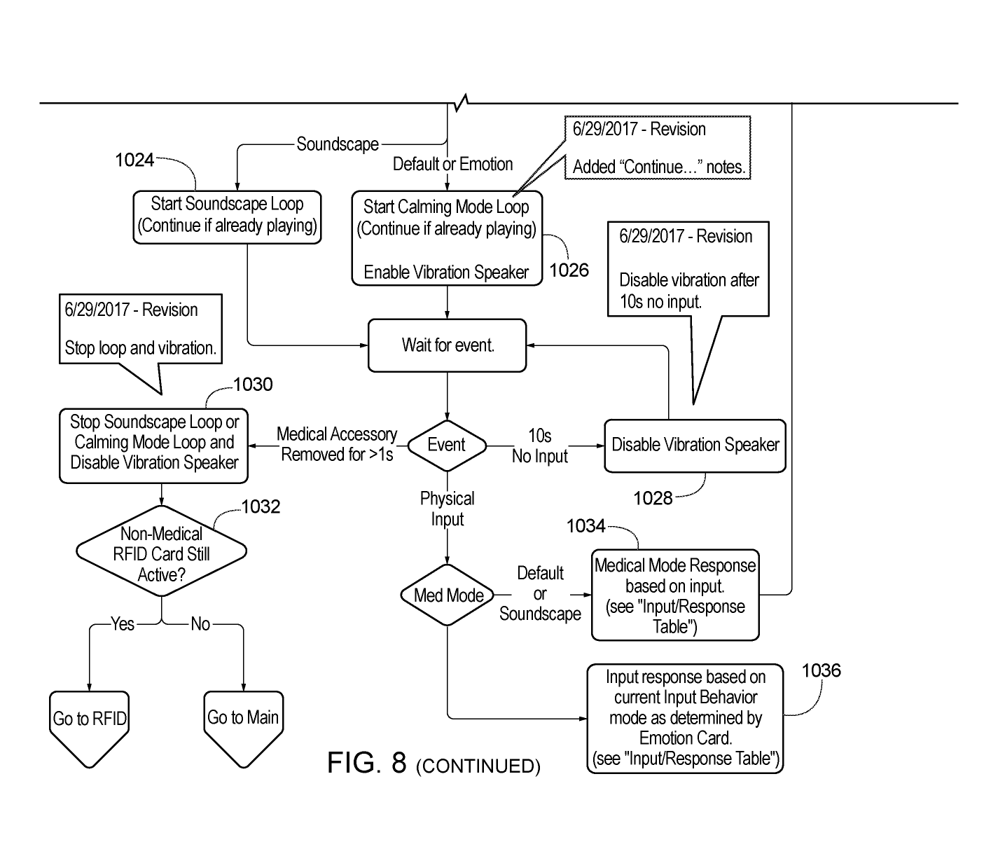

FIG. 8 illustrates an embodiment in which the emotion card 400 is a medical card. If it is determined that card 400 is a medical card, then duck 100 is set to medical play mode if a soundscape is already playing then duck 100 may continue to play the soundscape 1024. If no soundscape is playing, but a soundscape is entered (either via the app or via a soundscape card) then duck 100 may begin to play the soundscape 1024. If no soundscape is playing or entered, then duck 100 may be placed into medical mode 1026 in which vibrational speaker 250 is turned on for a calming effect (e.g. emulating a calm heartbeat and/or breathing). If no input is received for a predetermined time (e.g. 10 seconds) vibrational speaker 250 may be turned off. If the medical card is removed 1030 the soundscape, calming mode and vibrational speaker 250 may be discontinued. If no other cards 400 are present duck 100 returns to default mode. If one or more cards are still present 1032 duck 100 may continue to act according to the cards present. If a new card is received then the medical play mode may be modified according to the new card 1034/1036.

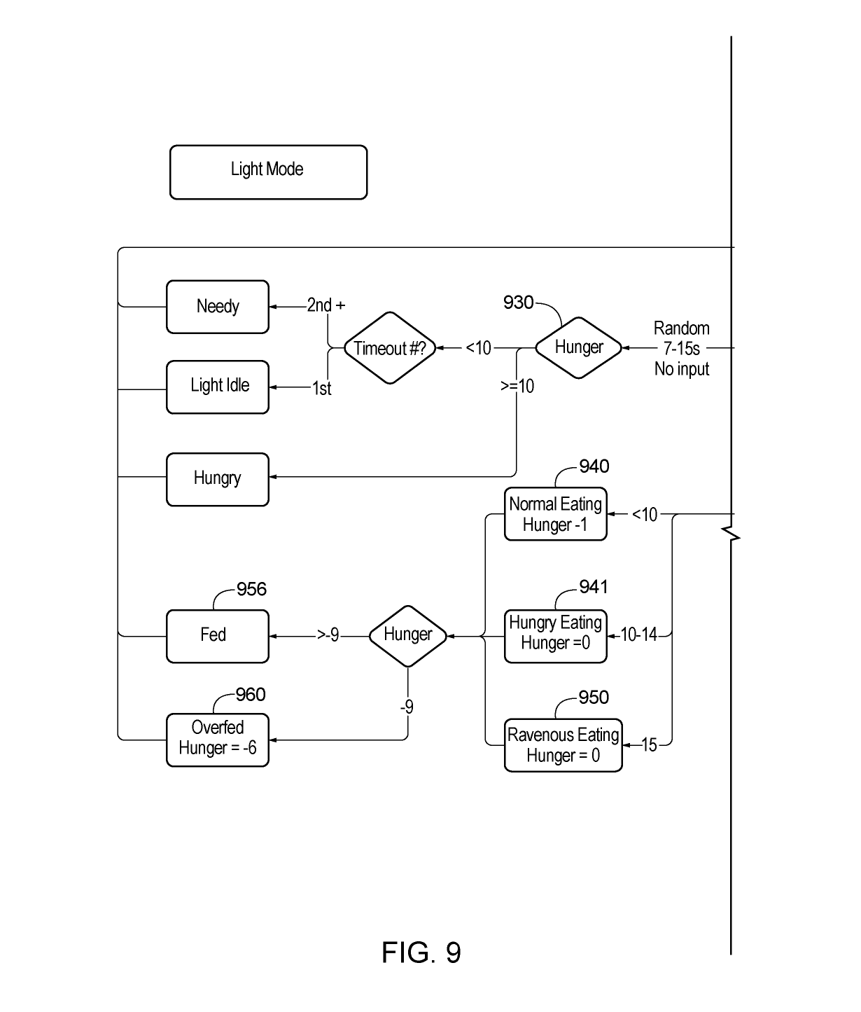

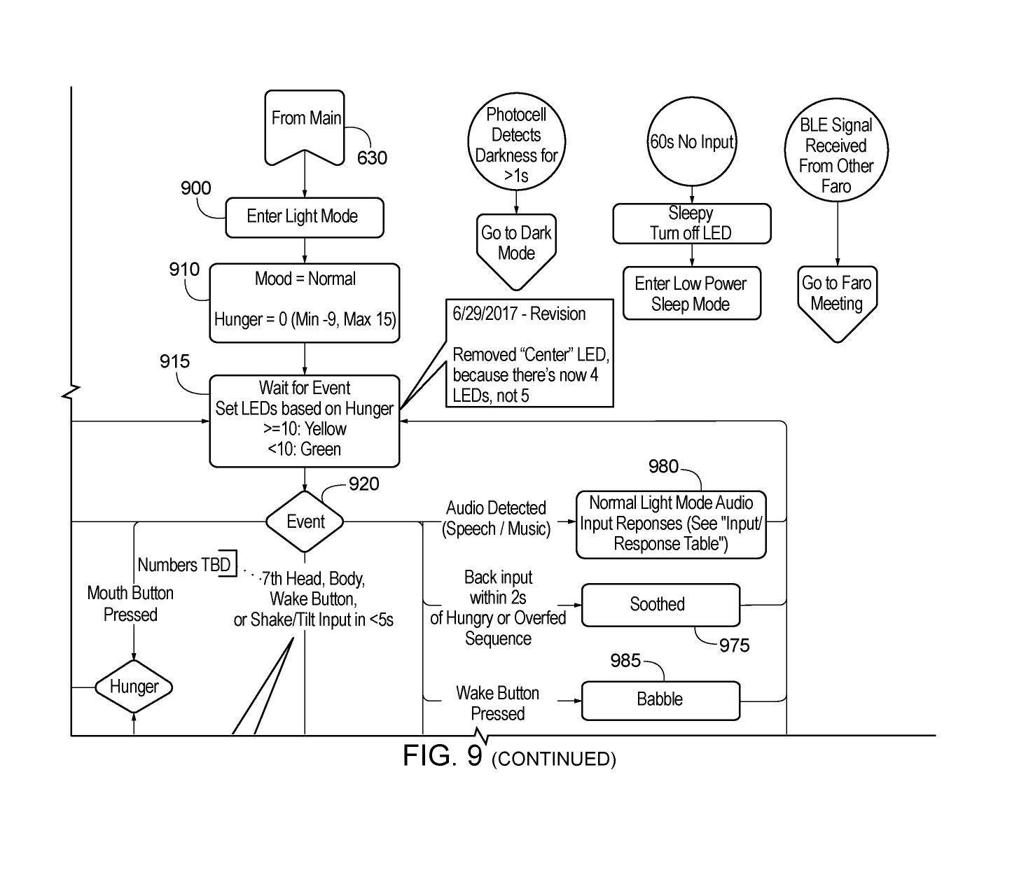

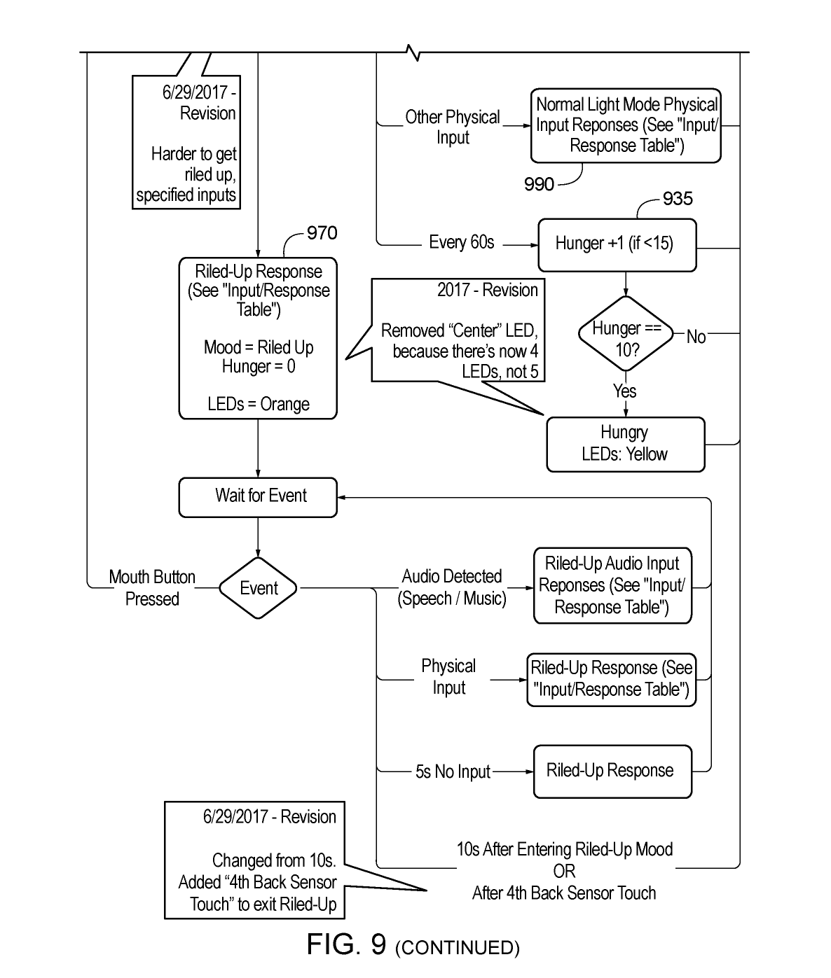

FIG. 9 illustrates an embodiment in which no cards 400 or input from the app have been received by duck 100, but duck 100 detects that it is light in its location. At 900, duck 100 enters light mode. It may set the mood to normal and enable a hunger meter 910. It may also set the LEDs to green or some other default color to indicate not hungry. After 10 seconds, or some other predetermined time period, the LEDs may be changed to yellow. At 920 duck 100 waits for additional input. If no input is received within a time range duck may indicate that it is getting hungry. All LEDs can change color or the number and color of LEDs may change as duck 100 become more or less hungry. After every 60 seconds (or some other predetermined time period) duck 100 becomes hungrier and hunger meter increases until it reaches a maximum hunger. At 940, if the tongue button is pressed while the hunger meter is less than 10, duck 100 makes regular eating noises and hunger meter may decrease by 1. At 945, if the hunger meter is between 10 and 14 inclusive, duck 100 will make hungry eating noises and the hunger meter will return to zero. At 950, if the hunger meter is at 15, duck 100 will make ravenous eating noises and the hunger meter will return to zero. If the tongue button is continued to be pressed after hunger meter falls to zero, hunger meter will continue to decrease during which time 955 duck 100 will be in a fed state, until it reaches −9 at which point it reaches an overfed state 960. If at step 975, back sensor is activated within 2 seconds of a hungry or overfed indication, duck 100 may be soothed. If, however, back sensor is activated more than 4 times duck 100 may enter riled-up mode.

If at any point during light mode, duck 100 is shaken or tilted or a sensor is pressed more than 7 times (could be designed for fewer than or greater than 7 times), duck 100 enters a riled-up mode 970. While in riled-up mode duck 100 may make riled-up noises and/or may vibrate.

If duck 100 is not riled-up, and it receives an audio input, it responds accordingly. For example, if music is detected duck 100 may begin to dance. If at step 985 the wake button is pressed and duck 100 is not in riled-up mode, duck 100 may produce babbling noises. If other physical input is received when duck 100 is not in riled-up mode it will respond accordingly.

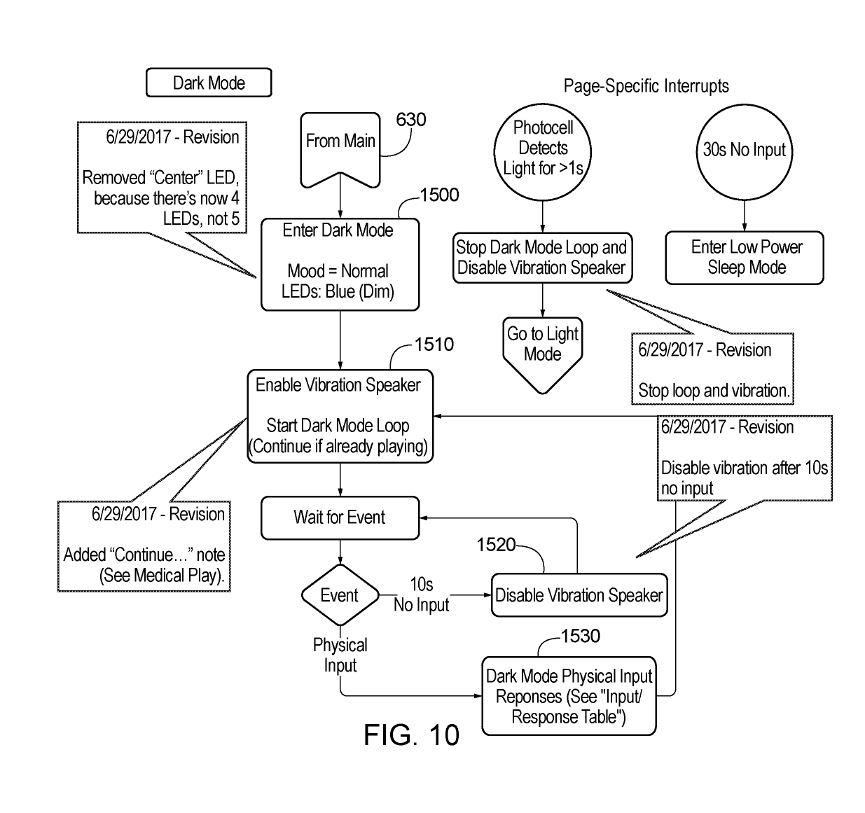

FIG. 10 illustrates an embodiment in which no cards 400 or input from the app have been received by duck 100, but duck 100 detects that it is dark in its location. At 1500, duck 100 enters dark mode. It may set the mood to normal, turn the LEDs blue and slow down any movements. In dark mode at 1510, duck 100 may also enable vibration speaker 250 to emulate breathing and/or a heartbeat. If after a period of time (e.g. 10 seconds) no input is detected 1520, duck 100 may disable vibrational speaker 250. If instead physical input is detected at 1530, duck 100 may respond as in a lighted environment, only at a slower rate.

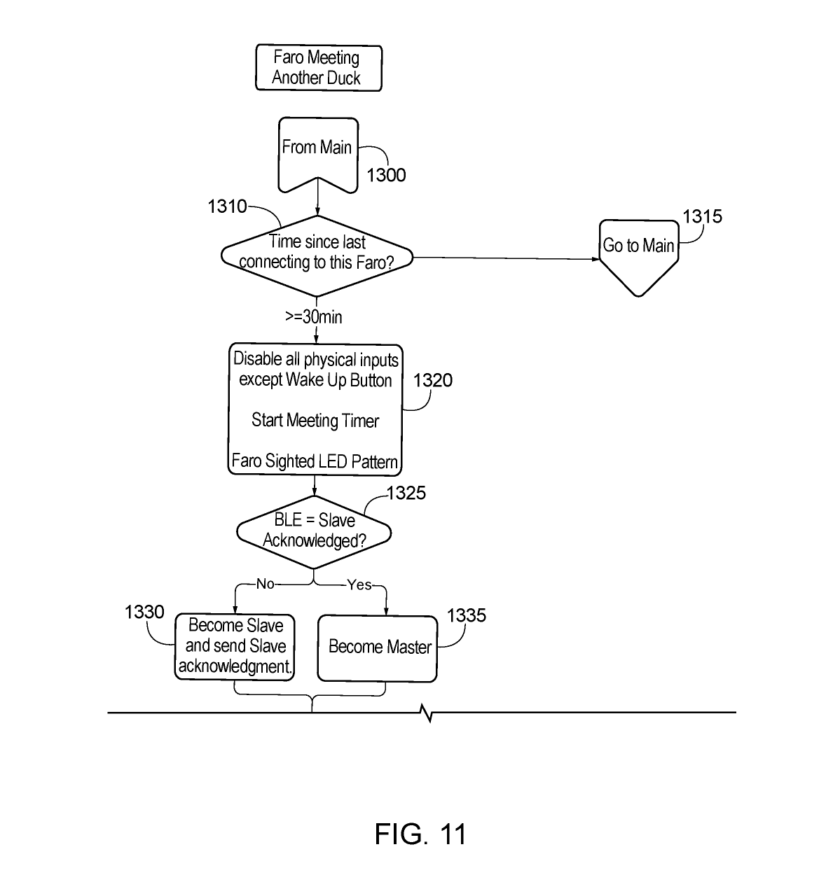

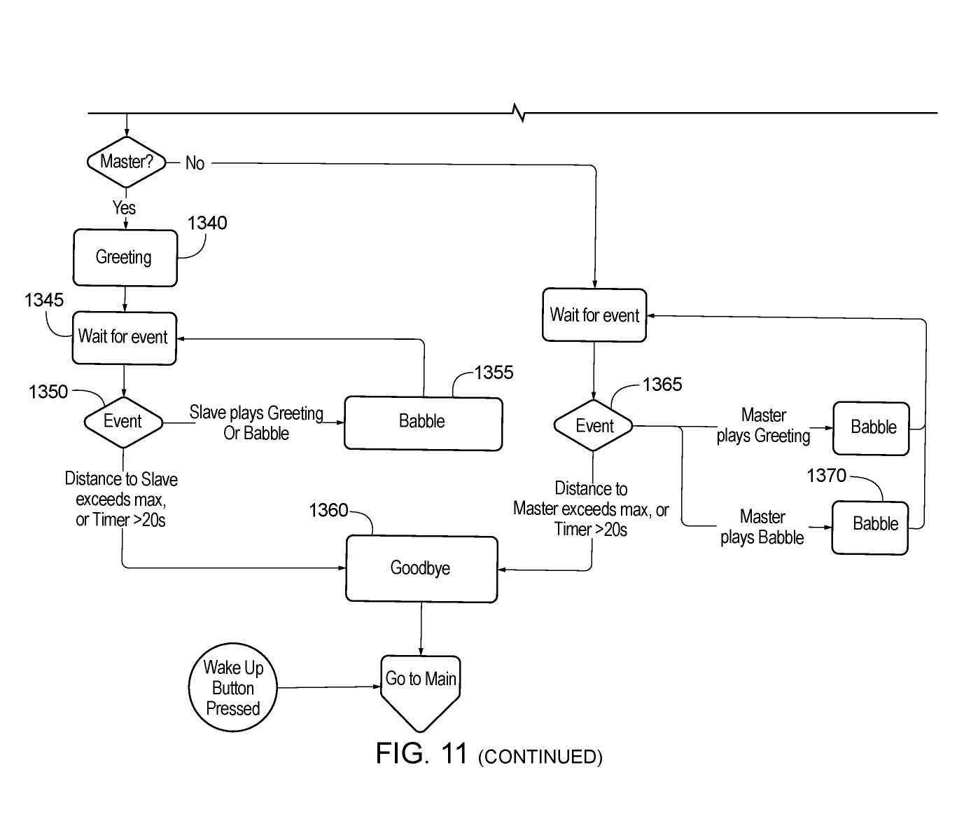

FIG. 11 illustrates a possible interaction between multiple dolls 100. In one or more embodiments when two dolls 100 come within a certain distance of each other, one or both will automatically identify that another doll is within range. In one or more embodiments, doll 100 may be notified through a card 400 that it will be meeting another doll. The first time two dolls 100 meet one doll 100 will start a meeting timer and may disable all other inputs other than the wake button. When the doll 100 receives a BLE signal it determines at 1325 if the signal is a slave signal 1335 or not at 1330. If a slave signal is received then the duck receiving the signal becomes the master, otherwise it becomes the slave and send an acknowledgement of that state. If the doll is a master doll then it plays a greeting or a babble 1340, which may include audio and/or a physical movement. It then waits 1345 for the slave doll to respond with a babble 1355. If the distance between the dolls exceeds a maximum distance and/or the timer exceeds 20 seconds (or some other predetermined time) with no response the master doll may play a goodbye audio and return to the main menu state. If the doll is the slave, it waits 1365 for the master greeting or babble 1370, if the distance between the dolls exceeds a maximum distance and/or the timer exceeds 20 seconds (or some other predetermined time) with no response the slave doll may play a goodbye audio and return to the main menu state.

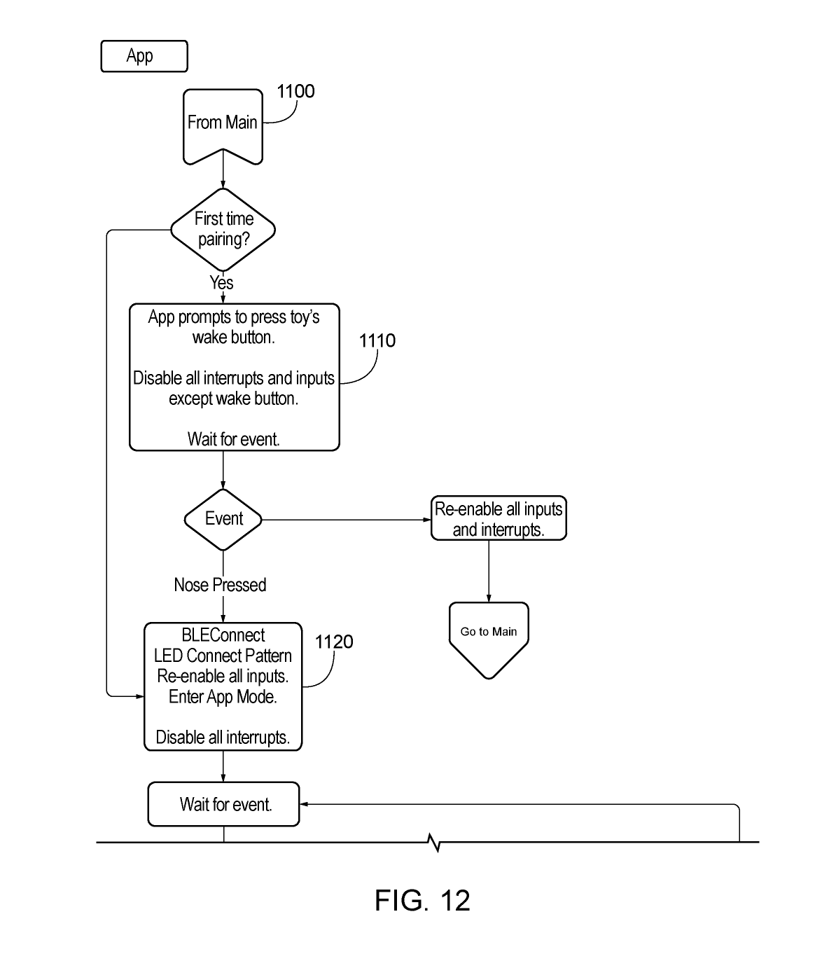

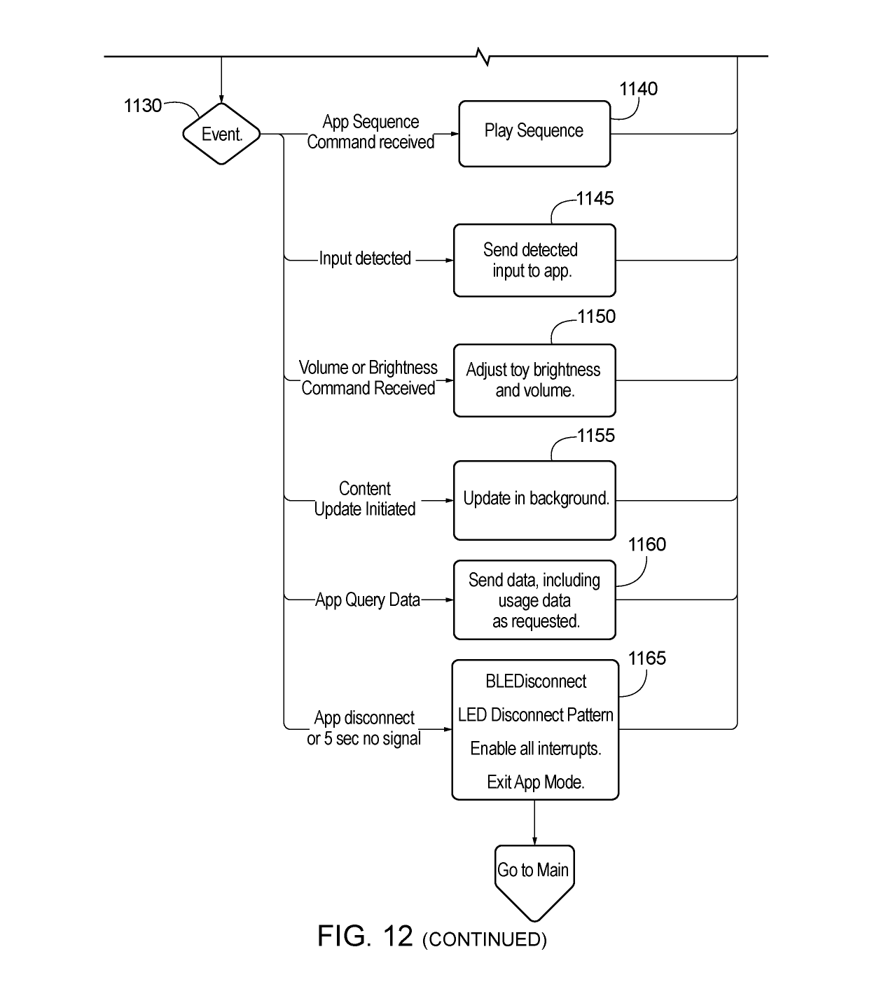

FIG. 12 illustrates duck 100 interacting with the app on a mobile device. At 1100 duck 100 receives a BLE signal from the app. If the app/device has never paired to duck 100 a pairing routine 1110 is performed. If the device has previously paired duck 100 enters app mode at 1120 and may disable all interrupts. Duck 100 then waits for an event 1130. An event may include an app sequence command 1140, in which case duck 100 may play the sequence; an input may be detected at duck 100, in which case the input may be sent to the app 1145; a volume and/or brightness command 1150 which may adjust the volume and/or brightness of the doll 100; an update command 1155 which may update doll software; app query 1160 in which case duck 100 uploads usage information; or app disconnect (which may include a time out after 5 a period such as 5 seconds) 1165, in which case duck 100 may disconnect from the app, enable the interrupts and exit app mode.

In each of the above modes, unless the interrupts are disabled, if at any time a card 400 is scanned, a BLE signal is received, or the on/mute/off button changes state duck may discontinue its current action and switch to the interrupt action. In each of the above embodiments, the various sensors may be electrically coupled to one or more processors which may or may not include a non-transitory computer-readable medium that includes one or more computer-executable instructions that, when executed by the one or more processors cause the duck to perform its various features and functions.

Having thus described preferred embodiments of the technology, advantages can be appreciated. Variations from the described embodiments exist without departing from a scope of one or more claims. It is seen that an animatronic doll provided. Although specific embodiments have been disclosed herein in detail, this has been done for purposes of illustration only, and is not intended to be limiting with respect to the scope of the claims, which follow. It is contemplated by the inventors that various substitutions, alterations, and modifications may be made without departing from the spirit and scope of the technology as defined by the claims. For example, different and/or additional individual or conjoined movements may be included. The combination of conjoined movements may be modified, etc. Other aspects, advantages, and modifications are considered within the scope of the following claims. The claims presented are representative of the technology disclosed herein. Other, unclaimed technology is also contemplated. The inventors reserve the right to pursue such technology in later claims.

Insofar as embodiments described above are implemented, at least in part, using a computer system, it will be appreciated that a computer program for implementing at least part of the described methods and/or the described systems is envisaged as an aspect of the technology. The computer system may be any suitable apparatus, system or device, electronic, optical, or a combination thereof. For example, the computer system may be a programmable data processing apparatus, a computer, a Digital Signal Processor, an optical computer or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by one or more application specific integrated circuits and/or optical elements. Suitably, the computer program can be stored on a carrier medium in computer usable form, which is also envisaged as an aspect of the invention. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

It is accordingly intended that all matter contained in the above description or shown in the accompanying drawings be interpreted as illustrative rather than in a limiting sense. It is also to be understood that the following claims are intended to cover the generic and specific features of the technology as described herein, and all statements of the scope of the technology which, as a matter of language, might be said to fall there between.

Having described the technology, what is claimed as new and secured by Letters Patent is:

1. An interactive doll that performs automated movements, the doll comprising:
an outer shell that forms a shape of the doll;
a plurality of movable body parts within the outer shell;
a plurality of motors disposed within the outer shell for moving the movable body parts;
a plurality of sensors disposed on the outer shell;
at least one processor in electrical communication with the plurality of sensors;
at least one identification card readable by at least one of the plurality of sensors;
wherein the at least one identification card identifies a mode for the doll; and
the processor placing the doll into a mode identified by the at least one identification card.

2. The doll according to claim 1 wherein the identification card includes a simulated medical port.

3. The doll according to claim 2 wherein the processor places the doll into a medical mode wherein the doll emulates receiving chemo-therapy.

4. The doll according to claim 1 wherein said doll includes a speaker electrically coupled to the processor; wherein the identification card includes a soundscape; and the processor causes the speaker to play the soundscape.

5. The doll according to claim 1 wherein at least one sensor includes a Bluetooth detector.

6. The doll according to claim 5 further including a mobile device running a software application pairs with doll through the Bluetooth detector.

7. The doll according to claim 5 wherein another doll interacts with the doll through the Bluetooth detector.

8. The doll according to claim 1 wherein at least one of the sensors is a photocell light detector; wherein when the light detector detects a light environment it places the doll into a light environment mode and when the light detector detects a dark environment it places the doll into a dark environment mode such that the light mode and dark mode are different modes.

9. The doll according to claim 8 wherein the light mode includes the doll emulating hunger; the doll further including a button electrically coupled to the processor for emulating feeding the doll.

10. The doll according to claim 1 further including a speaker electrically coupled to the processor; wherein the speaker is a vibrational speaker and the speaker emulates a heartbeat.

11. A method of interacting with a doll that performs automated movements, the method comprising:
a light sensor in the doll detecting a light environment around the doll;
a processor receiving the light indication from the light sensor and placing the doll into a mode that includes the doll emulating hunger.

12. The method according to claim 11 further comprising;
receiving an input to the doll through a button that is electrically coupled to the processor, wherein the input indicates to the processor that the doll is being fed.

13. The method according to claim 11 further comprising:
a sensor in the doll detecting a card that is placed near the doll;
the processor, in response to the sensor detecting the card, interrupting the hunger mode, identifying the card and placing the doll into a mode indicated by the card.

14. The method according to claim 13 wherein the card includes a simulated medical port and wherein the processor places the doll into a medical mode wherein the doll emulates receiving chemo-therapy.

15. The method according to claim 11 further including the doll receiving a signal from a mobile device; the doll disabling an interrupt capability and the doll interacting with a software application on the mobile device.

16. The method according to claim 15 wherein the interaction includes uploading usage data.

17. The method according to claim 15 wherein the interaction includes updating a software in the doll.

18. The method according to claim 15 wherein the interaction includes the doll receiving a sequence of commands and the doll performing the commands.

19. The method according to claim 15 wherein the interaction includes adjusting an aspect of the doll in response to a message received from the mobile device.

20. The method according to claim 11 further including the doll receiving a signal from another doll; the doll disabling at least one sensor and the doll interacting with the another doll.
